(19) United States
(12) Patent Application Publication
(10) Pub. No.: US 2006/0055544 A1
(43) Pub. Date: Mar. 16, 2006

(54) Signaling device

(76) Inventor: Fred N. Morguelan, Westlake Village, CA (US)

Correspondence Address: JAMES E. BRUNTON, ESQ., P. O. BOX 29000, GLENDALE, CA, 91209, US

(21) Appl. No.: 10/938,700

(22) Filed: Sep. 10, 2004

(51) Int. Cl. G08B 23/00; G08B 3/00

(52) U.S. Cl. 340/573.1; 340/691.1

(57) ABSTRACT

A portable, handheld, battery powered signaling device for emitting signals corresponding to a physical sensation being experienced by the user of the device. The device includes a handgrip portion and a novel sensor in the form of a force sensitive resistor, which changes resistance when a gripping force is applied by the user to the handgrip portion of the device. The sensor is operably interconnected with signaling devices in the form of visible and audible signals, which are energized when the user squeezes the handgrip. By exerting greater or lesser forces on the handgrip the user is able to control the visible and audible signals and in this way quantify the degree of the physical sensation being experienced.

### BACKGROUND OF THE INVENTION

1. Field of the Invention

The present invention relates generally to signaling devices. More particularly, the invention concerns a battery powered, handheld device for signaling physical and emotional responses of the user.

2. Discussion of the Prior Art

A wide variety of handheld signaling devices used for numerous purposes have been suggested in the past. Many such devices are used in the hospital environment for use by a patient to signal the need for attention. For example, various types of handheld devices are provided adjacent the hospital bed for use by the patient to call for a caregiver or to regulate the delivery of medicaments.

In addition to the medical field, numerous types of signaling devices have been suggested for use in the industrial environment. For example, handheld signaling devices have been used to start and stop various types of machines, to indicate operational status and to emit distress signals.

Other common types of handheld signaling devices include vehicle door lock signaling devices, garage door opening devices and various types of personal protection devices.

However, applicant is unaware of any type of prior art handheld signaling device, such as the device of the present invention, that is specially designed for emitting signals corresponding to physical sensations, such as feelings out of pain and passion being experienced by the user and for quantifying the sensations. By way of nonlimiting example, the devices of the present invention can be used by dental patients during the conduct of dental procedures to indicate to the dentist that pain is being experienced by the patient and to indicate the level of such pain. The devices of the present invention can also be used during intimate encounters to signal to a partner feelings of pleasure and passion and to quantify these feelings by means of visual and audible signals.

### SUMMARY OF THE INVENTION

It is an object of the present invention to provide a portable, handheld, battery powered signaling device for emitting signals corresponding to a physical sensation being experienced by the user of the device.

Another object of the invention is to provide a device of the aforementioned character that enables the user to quantify the degree of the physical sensation being experienced.

Another object of the invention is to provide a device of the character described in the preceding paragraph in which the physical sensations being experienced by the user of the device can be quantified by the user by exerting greater or lesser forces on the hand grip portion of the device.

Another object of the invention is to provide a device as described herein which includes a novel hand operated sensor in the form of a force sensitive resistor which changes resistance when a gripping force is applied by the user to the hand grip portion of the device.

Another object of the invention is to provide a device of the class described in which both visible and audible signals can be emitted from the device.

Another object of the invention is to provide a device of the character described in the preceding paragraph in which the visible signals comprise a plurality of illuminable-illuminatable-lights and in which the audible signals emanate from a novel noise generating system housed within the device housing.

Another object of the invention is to provide a device of the class described in the preceding paragraphs which is compact, easy to use and readily portable.

Another object of the invention is to provide a signaling device of the character described in the preceding paragraphs that is of a simple design and one that can be relatively inexpensively produced.

### BRIEF DESCRIPTION OF THE DRAWINGS

FIG. 1 is a generally perspective, exploded front view of one form of the hand operated signaling device of the invention.

FIG. 2 is a generally perspective, rear view of the hand operated signaling device shown in FIG. 1.

FIG. 3 is a right side view of the device shown in FIG. 1, partly broken away to show internal construction.

FIG. 4 is a cross-sectional view taken along lines 4-4 of FIG. 3.

FIG. 5 is a cross-sectional view taken along lines 5-5 of FIG. 3.

FIG. 6 is a left-hand side view of the device shown in FIG. 1.

FIG. 7 is a view taken along lines 7-7 of FIG. 5.

FIG. 8 is a cross-sectional view taken along lines 8-8 of FIG. 5.

FIG. 9 is a cross-sectional view taken along lines 9-9 of FIG. 5.

FIG. 10 is a generally perspective exploded view of the handle grip portion of the apparatus of the invention.

FIG. 10A is an enlarged, fragmentary view of the switch and circuit board portions of the apparatus of the invention shown in FIG. 4.

FIG. 11 is a fragmentary top plan view of the switch and circuit board portions of the apparatus of the invention and of selective signal lights of the apparatus; and

FIGS. 12A and 12B when considered together comprise a generally diagrammatic view of one form of the operating circuit of the apparatus of the invention.

### DESCRIPTION OF THE INVENTION

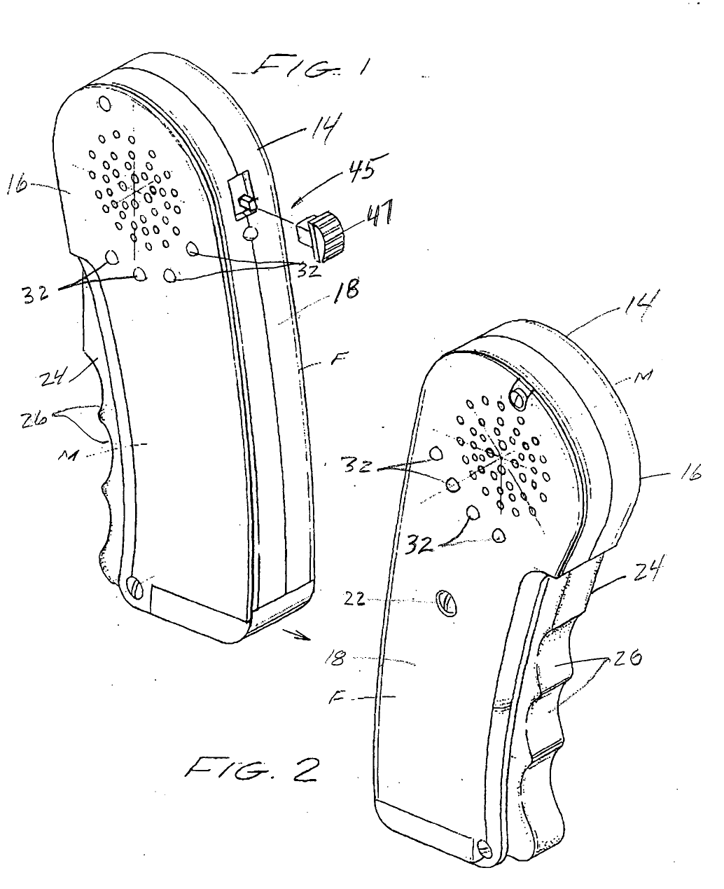

Referring to the drawings and particularly to FIGS. 1 through 5, one form of the handheld signaling device for emitting signals corresponding to a physical sensation being experienced by the user is there shown. In the present form of the invention the signaling device comprises a housing 14 made up of cooperating first and second side members 16 and 18, which are interconnected in the manner shown in FIG. 3 to define an internal chamber 20 (FIG. 3). Side members 16 and 18 are preferably constructed from a moldable plastic, but could also be formed of other suitable materials.

Operably interconnected with housing 14 by means of connector pins 22 and 23 (FIG. 10) is gripping means for gripping by one hand of the user. This important gripping means here comprises a uniquely configured gripping member 24 that is provided with a plurality of recesses 26 to accept the fingers of the user. Gripping member 24 is preferably formed from an elastomeric material such as polyurethane and, for a reason presently to be described, is movable relative to said housing between first and second positions.

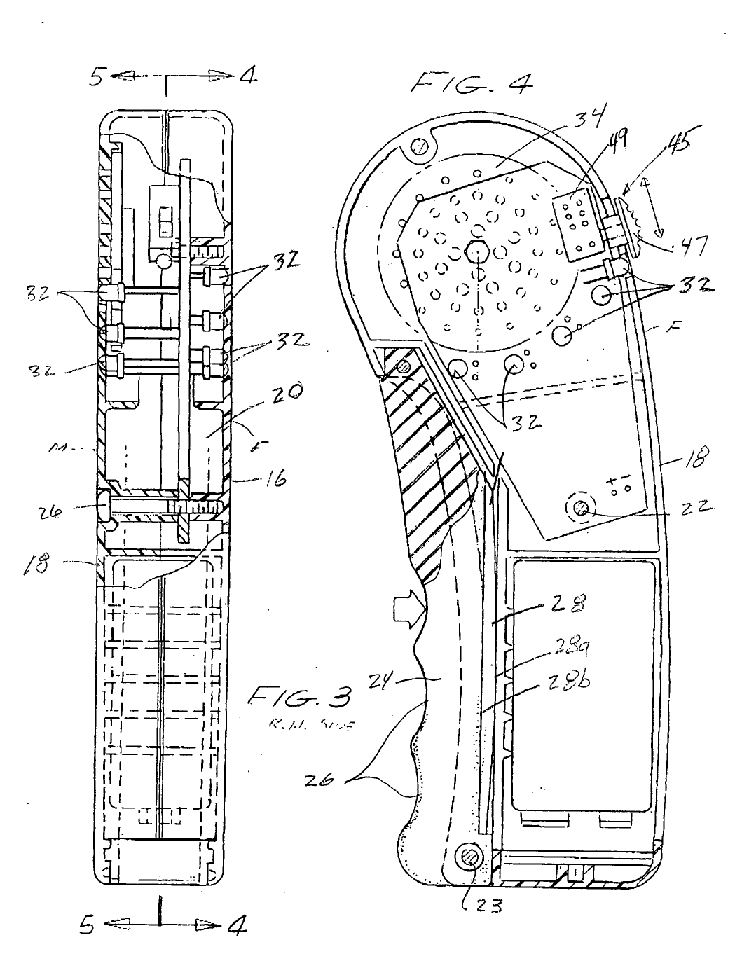

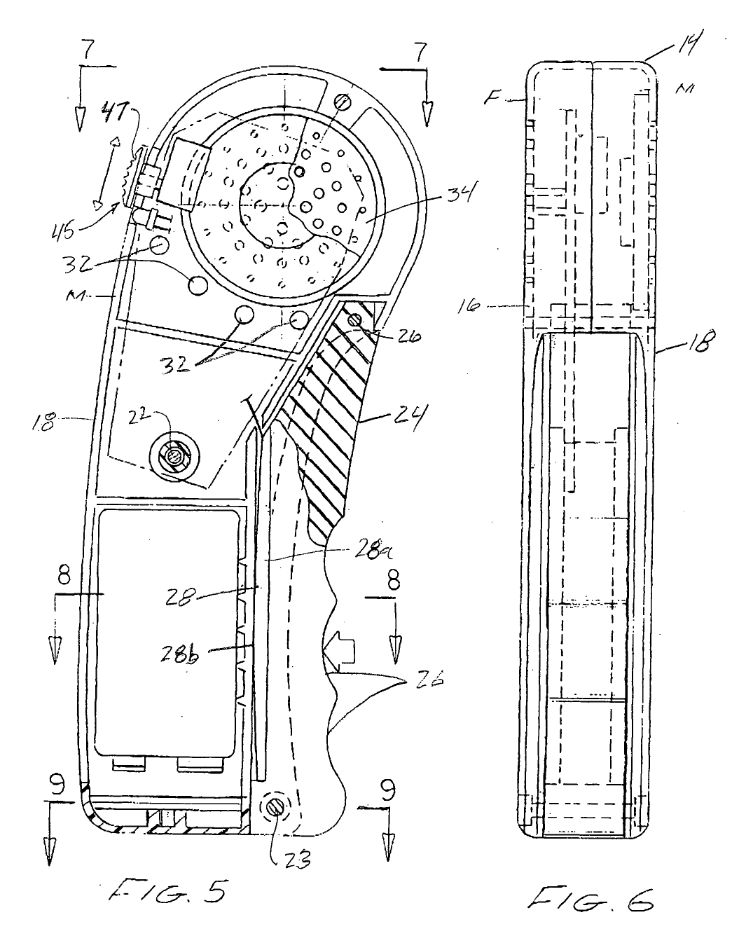

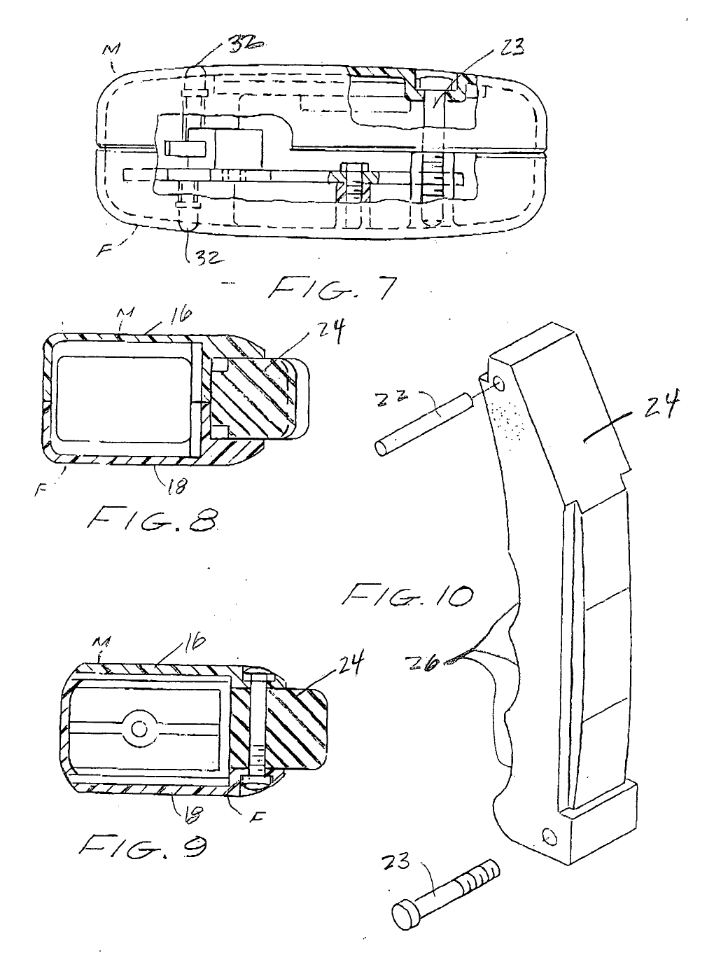

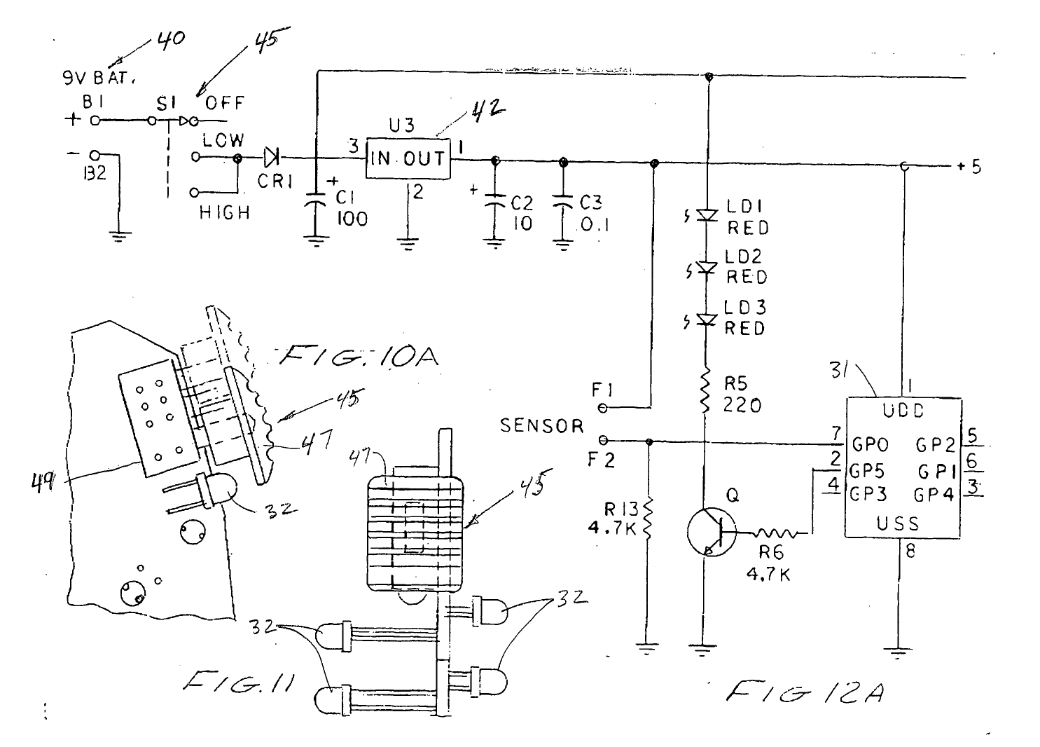

Operably associated with the gripping means is a novel sensor means for sensing pressure exerted on the gripping means by the user and for emitting a signal in response thereto. This important sensor means here comprises a pressure sensor 28 having spaced apart sidewalls 28a and 28b which, as best seen in FIGS. 4 and 5 are disposed between one side of the housing 14 hand of the gripping means, or gripping member 24. In the present form of the invention, pressure sensor 28 is readily commercially available from Tekscan, Inc. of South Boston, Mass. Details of the construction and operation of this novel sensor can be obtained from the Tekscan Company and are also described in detail in U.S. Pat. No. 6,272, 936 issued to Oreper et al. The sensor is well suited for use in the signaling device of the present invention, in that it basically comprises a force sensitive resistor that measurably changes its resistance when a force is applied to the sensor and can be adapted to generate and transmit signals corresponding to these changes in resistance

As indicated in the drawings, signaling means which are carried by housing 24 are operably associated with the sensor means for receiving the signals generated thereby and for emitting visual and audible signals in response thereto. In the present form of the invention the signaling means comprises a plurality of illuminable lights 32 mounted at various spaced apart locations on the housing (FIGS. 1 and 2) and an audible noise generating device, including a speaker 34 that is disposed within internal chamber 20 of the housing. Lights 32 are here provided in the form of spaced apart, readily commercially available light emitting diodes (LEDs) and are preferably provided in different colors (see FIGS. 12A and 12B).

Also comprising an important aspect of the apparatus of the present invention is electrical circuit means for interconnecting the sensor means and the signaling means. This electrical circuit means is here provided in the form of the circuit shown in FIGS. 12A and 12B of the drawings. As indicated in these figure drawings, the circuit is comprised of the previously identified force sensor 28, a microcontroller, here shown as comprising a programmable microchip 31, the several previously mentioned LEDs 32, and a conventional, commercially available audio amplifier 33 for driving the speaker 34.

The circuit is powered by a conventional 9-volt battery 40. During operation of the device, the battery voltage is converted by a conventional, readily commercially available voltage regulator 42 from 9 volts down to a constant 5 volts to appropriately power the microcontroller. The raw battery voltage drives the LEDs 32 and the audio amplifier 33 in a conventional manner.

As previously mentioned, the sensor is in the nature of a “Force Sensitive Resistor” which is a device that changes its resistance when a force is applied. This resistance change is converted in a conventional manner to a voltage by connecting it in one half of a voltage divider. The varying voltage is measured by an internal analog to digital converter, which forms a part of the microcontroller 31. The variable voltage is then used to generate an audio signal the frequency of which is proportional to the change in the force exerted on the sensor means or handgrip 24 by the device user. During operation of the device, the varying voltage is also used to appropriately power the LEDs 32 and to change their flash rate in proportion to the varying voltage and in proportion to the force exerted on the hand grip by the device user.

It is to be understood that microcontroller 31 is a complete central processing unit (CPU) which has an internal clock generator, Flash Memory for the program, RAM memory for variables, I/O pins for sensing and control, an Analog to Digital converter for measuring voltage, and a hardware Pulse Width Modulation module. A custom program, which is of a character well understood by those skilled in the art, is stored permanently in the Flash Memory, and controls the complete operation of the circuit. The internal clock controls the speed of all internal operations. The Analog to Digital Converter converts the variable analog voltage input from the Force Sensor to a digital representation, which is then used to control the Pulse Width Modulation module, which outputs the variable frequency audio tone. A software timer controls the flashing speed of the LEDs.

With the foregoing in mind, during the event taking place, the user turns the signaling device on using the switching means of the invention and grips the device with one hand so that the user's fingers overlay the gripping member 24.

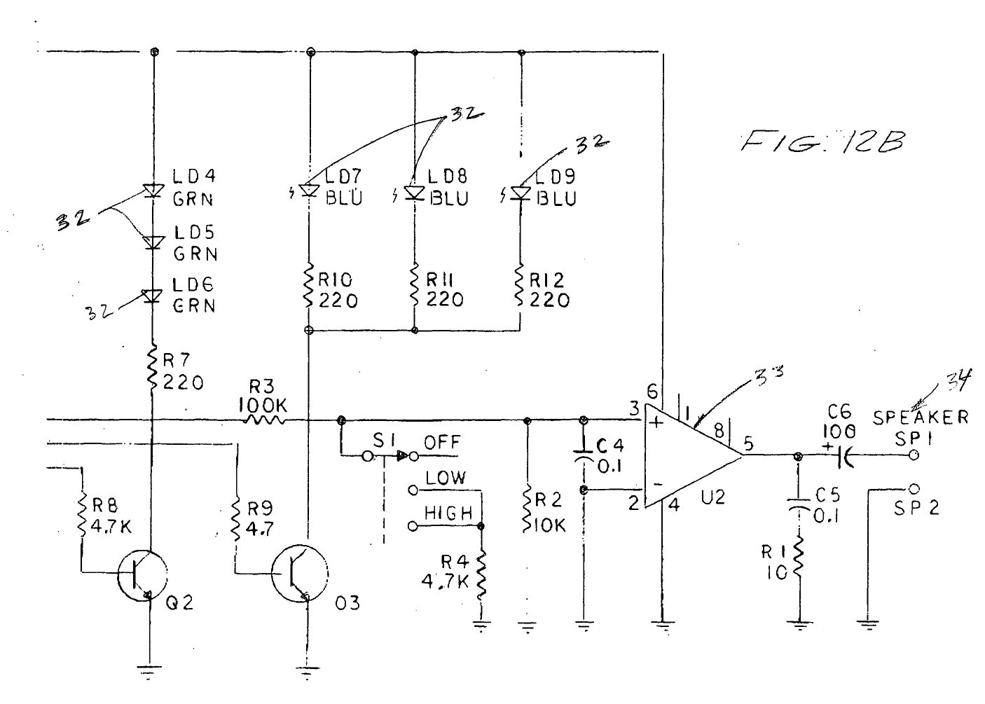

Referring to FIGS. 1, 4, 10, 11 and 12A, the switching means here comprises a commercially available switching mechanism generally designated by 45. While the switching mechanism can be obtained from various sources, a slide switch sold by the Digi-Key Company of Thief Falls, Minn. has proven to be satisfactory for the present application. The switching mechanism here comprises a finger engaging pad 47 that is slidably connected to a support platform 49 that is appropriately connected to the housing 14 and the manner shown in FIG. 3. As indicated in FIG. 10A, by sliding the finger pad from the position shown in the solid lines in FIG. 10A to the position shown in the phantom lines, the switch can be moved from an “off” position to a “low” position and finally to a “high” position (see also FIG. 12A). With a switch in the “high” position the LEDs illuminate more brightly and the audio signal emitted from the speaker is louder.

By way of non-limiting example, if the event taking place concerns the performance of a dental procedure, the user would turn the device on and grip the signaling device at the commencement of the procedure. At any time during the conduct of the procedure the user can exert a variable squeezing pressure on the handgrip. This squeezing pressure causes a change in the resistance of the sensor, which, in turn, causes a voltage signal to be sent to the microcontroller 31. The microcontroller, in response to this signal, causes the LEDs 32 to flash and causes the speaker 34 to emit an audio signal indicating to the dentist that the user is experiencing pain. If, due to an increase in pain, the user exerts a greater pressure on the hand grip, the resistance of the sensor means will change further causing a voltage signal of a different character to be sent to the microcontroller 31. The microcontroller in response to this varying signal will cause the LEDs to flash at a greater rate and will cause the speaker 34 to emit a louder audio signal. This indicates to the dentist that the user is experiencing a greater pain.

If, by way of further example, the event taking place is in the nature of an intimate encounter, the user can use the signaling device to discretely indicate to his or her partner varying degrees of passion and pleasure that are being experienced. As in the earlier example, a squeezing pressure exerted on the handgrip will cause a change in the resistance of the sensor, which, in turn, will cause a voltage signal to be sent to the microcontroller 31. The microcontroller, in response to this signal, will cause the LEDs 32 to flash and will cause the speaker 34 to emit an audio signal indicating to the partner that the user is experiencing a particularly pleasurable sensation. If the user exerts a greater pressure on the hand grip, due to an increase in pleasure, the resistance of the sensor means will change further causing a voltage signal of a different magnitude to be sent to the microcontroller 31. The microcontroller in response to this different signal will cause the LEDs to flash at a greater rate and will cause the speaker 34 to emit a louder audio signal. This indicates to the partner that the user is experiencing greater passion and pleasure.

When, because of shyness or inexperience, one or both of the partners in an intimate encounter often find it difficult to audiblize their emotions, the signaling device of the present invention provides an ideal mechanism for discretely, but yet positively, communicating to their partner those actions that they find particularly pleasurable.

1. A handheld signaling device for emitting signals corresponding to a physical sensation being experienced by the user, comprising:
(a) a housing having an internal chamber;
(b) gripping means connected to said housing for gripping by the user to exert a pressure thereon corresponding to the degree of the physical sensation being experienced by the user;
(c) sensor means operably associated with said gripping means for sensing pressure exerted thereon by the user and for emitting a signal in response thereto; and
(d) signaling means operably associated with said sensor means for receiving said signal from said sensor means and for emitting a signal in response thereto.

2. The signaling device as defined in claim 1 in which said signaling means comprises an illuminable light mounted on said housing.

3. The signaling device as defined in claim 1 in which said signaling means comprises an audible noise generating device mounted within said chamber of said housing.

4. The signaling device as defined in claim 1 in which said sensor means comprises a force sensitive resistor that changes its resistance when a force is applied thereto.

5. The device as defined in claim 1 further including electrical circuit means carried by said housing for interconnecting said sensor means and said signaling means.

6. A handheld signaling device for emitting signals corresponding to a physical sensation being experienced by the user, comprising:
(a) a housing;
(b) gripping means connected to said housing for gripping by the user to exert a pressure thereon corresponding to the degree of the physical sensation being experienced by the user;
(c) sensor means operably associated with said gripping means for sensing pressure exerted thereon by the user and for emitting a signal in response thereto, said sensor means comprises a force sensitive resistor that changes its resistance when a force is applied thereto;
(d) signaling means operably associated with said sensor means for receiving said signal from said sensor means and for emitting a signal in response thereto, said signaling means comprising a plurality of illuminable lights mounted on said housing in a spaced apart relationship; and
(e) electrical circuit means carried by said housing for interconnecting said sensor means and said signaling means.

7. The signaling device as defined in claim 6 in which said electrical circuit means comprises with a microcontroller operably associated with said sensor means for receiving a signal there from.

8. The signaling device as defined in claim 6 in which said signaling means further comprises an audible noise generating device carried by said housing.

9. The signaling device as defined in claim 8 in which said audible noise generating device comprises a speaker.

10. A handheld, portable signaling device for emitting signals corresponding to a physical sensation being experienced by the user, comprising:
(a) a housing, including first and second interconnected side members, said side members cooperating to define an internal chamber;
(b) gripping means connected to said housing for gripping by the user to exert a pressure thereon corresponding to the degree of the physical sensation being experienced by the user, said gripping means comprising a hand grip movable by the user relative to said housing between first and second positions;
(c) sensor means operably associated with said gripping means for sensing pressure exerted thereon by the user and for emitting a signal in response thereto, said sensor means comprising a force sensitive resistor that changes its resistance in response to forces applied thereto by said hand grip moving between said first and second positions as a result of forces applied to said hand grip by the user;
(d) signaling means operably associated with said sensor means for receiving said signal from said sensor means and for emitting a signal in response thereto, said signaling means comprising a plurality of illuminable lights mounted on said housing in a spaced apart relationship and an audible noise generating device disposed within said internal chamber of said housing; and
(e) electrical circuit means carried by said housing for operably interconnecting said sensor means and said signaling means.

11. The signaling device as defined in claim 10 in which said electrical circuit means comprises with a microcontroller operably associated with said sensor means for receiving signals there from.

12. The signaling device as defined in claim 11 in which said audible noise generating device comprises a speaker.
